(19) United States
(12) Patent Application Publication
(10) Pub. No.: US 2016/0121309 A1
(43) Pub. Date: May 5, 2016

(54) Thermally Stable Zero PGM Catalysts System for TWC Application

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Ventura, CA (US)

(21) Appl. No.: 14/528,788

(22) Filed: Oct. 30, 2014

(51) Int. Cl. B01J 23/889

(52) U.S. Cl. CPC B01J 23/8892

(57) ABSTRACT

Effect of the type of material composition employed within overcoat in conjunction with ZPGM composition in impregnation layer on thermal stability and TWC performance of ZPGM catalyst systems is disclosed. Effect of aging temperature on thermal stability of disclosed ZPGM catalyst systems is also described. Testing of ZPGM catalyst samples including isothermal steady state sweep test condition and isothermal oscillating TWC test on disclosed ZPGM catalyst systems show that ZPGM catalyst system that includes combination of Cu₁Mn₂O₄ spinel and YMnO₃ perovskite exhibit higher level of thermal stability at temperature higher than temperatures registered for under floor application of TWC.

### BACKGROUND

1. Field of the Disclosure

The present disclosure relates generally to catalyst materials, and more particularly to a synergistic combination of two Zero-PGM (ZPGM) compositions to improve three-way catalyst (TWC) performance and thermal stability of ZPGM catalyst systems.

N/A

2. Background Information

Current TWC systems significantly increase the efficiency of conversion of pollutants and, thus, aid in meeting emission standards for automobiles and other vehicles. In order to achieve an efficient three-way conversion of the toxic components in the exhaust gas, conventional TWC includes large quantities of PGM material, such as platinum, palladium, and rhodium, among others, dispersed on suitable oxide carriers. Because catalysts including PGM materials provide a very high activity for the conversion of NOₓ, they are typically considered to be essential component of TWC systems.

Recent environmental concerns for a catalyst's high performance have increased the focus on the operation of a TWC at the end of its lifetime. Catalytic materials used in TWC applications have also changed, and the new materials have to be thermally stable under the fluctuating exhaust gas conditions. The attainment of the requirements regarding the techniques to monitor the degree of the catalyst's deterioration/deactivation demands highly active and thermally stable catalysts. As NO emission standards tighten and PGMs become scarce with small market circulation volume, constant fluctuations in price, and constant risk to stable supply, among others, there is an increasing need for new TWC catalyst compositions which may not require PGM and may be able to maintain efficient TWC of exhaust byproducts. There also remains a need for methods of producing such TWC catalyst formulations using the appropriate non-PGM materials.

According to the foregoing, there may be a need to provide catalytic properties which may significantly depend on the type of material, and aging temperatures for PGM-free catalyst systems, such that TWC performance and stability of ZPGM catalyst systems may be improved by providing suitable PGM-free catalytic layers.

### SUMMARY

For catalysts, in a highly dispersed and active form aiming at improving catalyst activity, after high temperature aging, a more effective utilization of the PGM-free catalyst materials may be achieved when expressed with most suitable selection of overcoat layer materials and impregnation layer materials.

According to embodiments in present disclosure, ZPGM catalyst systems may include at least a substrate, a washcoat layer, an overcoat layer, and an impregnation layer.

A plurality of ZPGM catalyst systems may be configured to include an alumina-based washcoat layer coated on a suitable ceramic substrate, an overcoat layer, which may include doped ZrO₂, or oxygen storage material (OSM), or may include ZPGM composition deposited on support oxide, such as YMnO₃/ZrO₂; and an impregnation layer which may include either Cu—Mn spinel, or a Cu—Co—Mn spinel.

In one embodiment, a ZPGM catalyst system referred to as ZPGM catalyst system Type 1, may include an alumina-based washcoat layer coated on a ceramic substrate, an overcoat layer of doped ZrO₂, and an impregnation layer with CuₓMn₃₋ₓO₄ spinel, where x=1.5.

In another embodiment, a ZPGM catalyst system referred to as ZPGM catalyst system Type 2, may include an alumina-based washcoat layer coated on a ceramic substrate, an overcoat layer with a suitable OSM, and an impregnation layer with CuₓCo_{y}Mn_{3-x-y}O₄ spinel, where x=y=1.0.

In a further embodiment, a ZPGM catalyst system referred to as ZPGM catalyst system Type 3, may include an alumina-based washcoat layer coated on a ceramic substrate, an overcoat layer with a combination of a ZPGM with zirconia type support oxide, such as YMnO₃/doped ZrO₂, and an impregnation layer with CuₓMn₃₋ₓO₄ spinel, where x=1.0.

According to embodiments in present disclosure, disclosed ZPGM catalysts systems may be aged at different temperatures, such as at about 850° C. and at about 900° C. under fuel gas composition.

Subsequently, aged ZPGM catalyst system samples may undergo testing to measure/analyze effect of type of ZPGM material compositions, and aging temperature, on TWC performance and thermal stability of disclosed ZPGM catalyst systems.

The activity of prepared ZPGM catalyst system samples, per variations of ZPGM material composition within impregnation layer and overcoat layer, may be determined and compared by performing isothermal steady state sweep test, after different aging condition, which may be carried out at a selected inlet temperature using an 11-point R-value from rich condition to lean condition. The NO conversion results from isothermal steady state test may be compared to show effect of aging temperature on TWC performance of spinel material and thermal stability of disclosed ZPGM catalysts.

Results from isothermal steady state sweep test and oscillating TWC test not only show that ZPGM catalyst system Type 3 exhibits high activity, but also that ZPGM catalyst system Type 3 has high thermal stability at higher aging temperature. The thermal stability may be enhanced by the synergistic effect between Cu—Mn spinel in impregnation layer and YMnO₃ perovskite in overcoat layer within configuration of ZPGM catalyst system Type 3.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates configuration for ZPGM catalyst system Type 1, which may include a washcoat with alumina type support oxide, an overcoat with doped ZrO₂ support oxide, and an impregnation layer with CuₓMn₃₋ₓO₄, according to an embodiment.

FIG. 2 shows a configuration for ZPGM catalyst system Type 2, which may include a washcoat with alumina type support oxide, an overcoat with oxygen storage material (OSM), and impregnation layer with CuₓCo_{y}Mn_{(3-x-y)}O₄ spinel, according to an embodiment.

FIG. 3 shows a configuration for ZPGM catalyst system Type 3, which may include a washcoat with alumina type support oxide, an overcoat with YMnO₃/doped ZrO₂ support oxide, and an impregnation layer with CuₓMn₃₋ₓO₄, according to an embodiment.

FIG. 4 depicts catalyst activity comparison in NO oxidation, HC conversion, and CO comparison for samples of ZPGM catalyst system Type 1 versus samples of ZPGM catalyst system Type 2, and versus samples of ZPGM catalyst system Type 3, tested according to oscillating TWC test methodology, at temperature of about 600° C., frequency of 1 Hz, fuel ratio span of 0.4, average R value of about 1.05 (stoichiometric condition), and SV of about 90,000 h⁻¹, according to an embodiment. Samples of ZPGM catalyst system Type 1, Type 2, and Type 3, were aged at 850° C. for about 20 hours, according to an embodiment.

FIG. 5 shows catalyst performance comparison for samples of ZPGM catalyst system Type 1, Type 2, and Type 3, under isothermal steady state sweep condition, from an R-value of about 2.0 (rich condition) to about 0.80 (lean condition), at inlet temperature of about 450° C. and SV of about 40,000 h⁻¹. Samples of ZPGM catalyst system Type 1, Type 2, and Type 3, were aged at 850° C. for about 20 hours, according to an embodiment.

FIG. 6 depicts catalyst activity comparison in NO oxidation, HC conversion, and CO comparison for samples of ZPGM catalyst system Type 1 versus samples of ZPGM catalyst system Type 2, and versus samples of ZPGM catalyst system Type 3, tested according to oscillating TWC test methodology, at temperature of about 600° C., frequency of 1 Hz, fuel ratio span of 0.4, average R value of about 1.05 (stoichiometric condition), and SV of about 90,000 h⁻¹, according to an embodiment. Samples of ZPGM catalyst system Type 1, Type 2, and Type 3, were aged at 900° C. for about 20 hours, according to an embodiment.

FIG. 7 shows catalyst performance comparison for samples of ZPGM catalyst system Type 1, Type 2, and Type 3, under isothermal steady state sweep condition, from about R-value of about 2.0 (rich condition) to about 0.80 (lean condition), at inlet temperature of about 450° C. and SV of about 40,000 h⁻¹. Samples of ZPGM catalyst system Type 1, Type 2, and Type 3, were aged at 900° C. for about 20 hours, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Platinum group Metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat or impregnation layer.

“Support oxide” refers to porous solid oxides, typically mixed metal oxides, which are used to provide a high surface area which aids in oxygen distribution and exposure of catalysts to reactants such as NOₓ, CO, and hydrocarbons.

“Oxygen storage material (OSM)” refers to a material/composition able to take up oxygen from oxygen rich streams and able to release oxygen to oxygen deficient streams, thus buffering a catalyst system against the fluctuating supply of oxygen to increase catalyst efficiency.

“Doped zirconia” refers to an oxide including zirconium and an amount of dopant from the lanthanide group or transition group of elements.

“Perovskite” refers to a catalyst having ABO₃ structure of material, which may be formed by partially substituting element “A” and “B” base metals with suitable non-platinum group metals.

“Milling” refers to the operation of breaking a solid material into a desired grain or particle size.

“Impregnation” refers to the process of imbuing or saturating a solid layer with a liquid compound or the diffusion of some element through a medium or substance.

“Incipient wetness (IW)” refers to the process of adding solution of catalytic material to a dry support oxide powder until all pore volume of support oxide is filled out with solution and mixture goes slightly near saturation point.

“Calcination” refers to a thermal treatment process applied to solid materials, in presence of air, to bring about a thermal decomposition, phase transition, or removal of a volatile fraction at temperatures below the melting point of the solid materials.

“Spinel” refers to any of various mineral oxides of magnesium, iron, zinc, or manganese in combination with aluminum, chromium, copper or iron with AB₂O₄ structure.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Conversion” refers to the chemical alteration of at least one material into one or more other materials.

“Air/Fuel ratio” or A/F ratio” refers to the weight of air divided by the weight of fuel.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

### DESCRIPTION OF THE DRAWINGS

The present disclosure may provide ZPGM catalyst systems with different material compositions including CuₓMn₃₋ₓO₄ spinel, and CuₓCo_{y}Mn_{3-x-y}O₄ spinel within impregnation layers in order to develop suitable catalytic layers capable of providing high reactivity and thermal stability for ZPGM catalysts. The diversified aspects that may be treated in present disclosure may include combination of ZPGM spinel layer with ZPGM with different structure such as perovskite that may show improvements in the process for overall catalytic conversion capacity and thermal stability which may be suitable for TWC applications for under floor or close couple catalyst positions.

According to embodiments, disclosed ZPGM catalyst systems may include at least a substrate, a washcoat layer, an overcoat layer, and an impregnation layer. A plurality of ZPGM catalyst systems may be configured to include an alumina-based washcoat layer coated on a suitable ceramic substrate, an overcoat layer of oxygen storage material, or doped ZrO₂, which may be combined with ZPGM composition and an impregnation layer including either a Cu—Mn spinel, or a Cu—Co—Mn spinel.

Catalyst Material Composition, Preparation, and Configuration

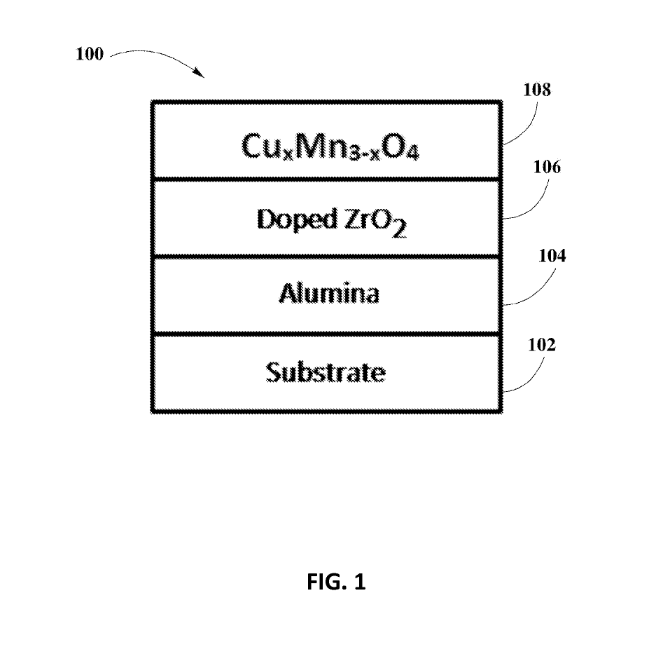

FIG. 1 shows a configuration for ZPGM catalyst system 100, according to an embodiment. As shown in FIG. 1, ZPGM catalyst system 100, referred to as ZPGM catalyst system 100 Type 1, may include at least a substrate 102, a washcoat 104, an overcoat 106, and an impregnation layer 108, where washcoat 104 may include alumina type support oxide, overcoat 106 may include doped ZrO₂ support oxide, and impregnation layer 108 may include CuₓMn₃₋ₓO₄ spinel, where x=0.05 to 1.5.

In order to manufacture ZPGM catalyst system 100, the preparation of washcoat 104 may begin by milling alumina (Al₂O₃) to make aqueous slurry. Then, the resulting slurry may be coated as washcoat 104 on substrate 102, dried and fired at about 550° C. for about 4 hours. The preparation of overcoat 106 may begin by milling doped ZrO₂ support oxide, such as Praseodymium-Zirconium support oxide (ZrO₂—Pr₆O₁₁) with water to make aqueous slurry. Then, the resulting slurry may be coated as overcoat 106 on washcoat 104, dried and fired at about 550° C. for about 4 hours. The impregnation layer 108 may be prepared by mixing the appropriate amount of Mn nitrate solution, and Cu nitrate solution with water to make solution at appropriate molar ratio for Cu_{1.5}Mn_{1.5}O₄, according to formulation CuₓMn₃₋ₓO₄, in which X may take value of 1.5, and where copper and manganese loading in final catalyst may be about 50 g/L. Subsequently, Cu—Mn solution may be impregnated to overcoat 106, then fired (calcined) at a temperature within a range of about 550° C. to about 800° C., preferably at about 550° C. for about 6 hours.

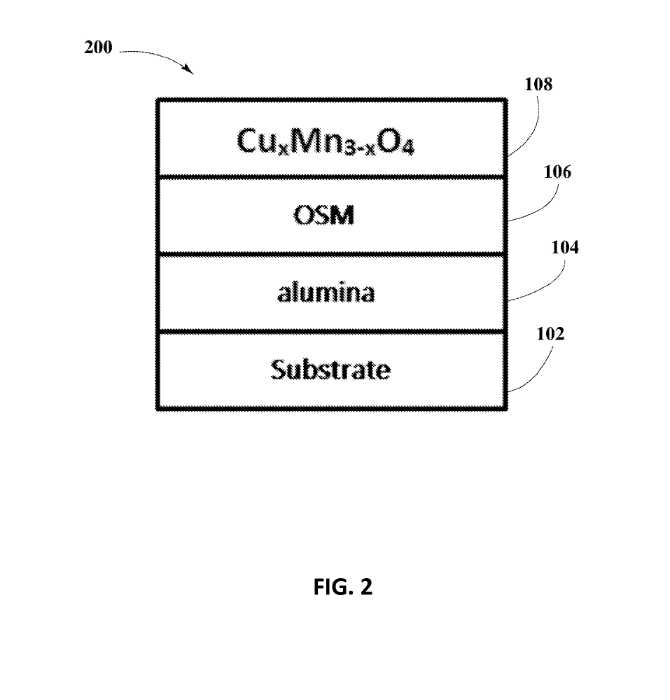

FIG. 2 shows a configuration for ZPGM catalyst system 200, according to an embodiment. As shown in FIG. 2, ZPGM catalyst system 200, referred to as ZPGM catalyst system 200 Type 2, may include at least a substrate 102, a washcoat 104, an overcoat 106, and an impregnation layer 108, where washcoat 104 may include alumina type support oxide, overcoat 106 may include oxygen storage material (OSM), and impregnation layer 108 may include CuₓCo_{y}Mn_{3-x-y}O₄ spinel.

In order to manufacture ZPGM catalyst system 200, the preparation of washcoat 104 may begin by milling alumina (Al₂O₃) to make aqueous slurry. Then, the resulting slurry may be coated as washcoat 104 on substrate 102, dried and fired at about 550° C. for about 4 hours. The preparation of overcoat 106 may begin by milling OSM, such as Cerium oxide-Zirconium oxide (CeO₂—ZrO₂) with water to make aqueous slurry. in present disclosure, OSM may include about 75% of CeO₂ and 25% of ZrO₂. Then, the resulting slurry may be coated as overcoat 106 on washcoat 104, dried and fired at about 900° C. for about 4 hours. The impregnation layer 108 may be prepared by mixing the appropriate amount of Mn nitrate solution, Cu nitrate solution, and Co nitrate solution with water to make solution at appropriate molar ratio for Cu₁Co₁Mn₁O₄, according to formulation CuₓCo_{y}Mn_{3-x-y}O₄, in which x may take value of 1, and y may take value of 1, and where copper, cobalt and manganese loading in final catalyst may be about 40 g/L. Subsequently, Cu—Co—Mn solution may be impregnated to overcoat 106, then fired (calcined) at a temperature within a range of about 550° C. to about 800° C., preferably at about 750° C. for about 5 hours.

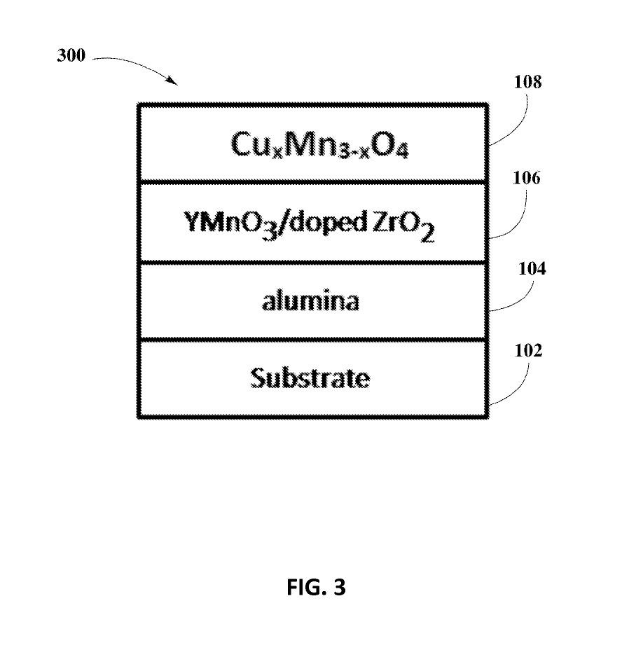

FIG. 3 shows a configuration for ZPGM catalyst system 300, according to an embodiment. As shown in FIG. 3, ZPGM catalyst system 300, referred to as ZPGM catalyst system Type 3, may include at least a substrate 102, a washcoat 104, an overcoat 106, and an impregnation layer 108, where washcoat 104 may include alumina type support oxide, overcoat 106 may include YMnO₃/doped ZrO₂ support oxide, and impregnation layer 108 may include CuₓMn₃₋ₓO₄ spinel.

In order to manufacture ZPGM catalyst system 300, the preparation of washcoat 104 may begin by milling alumina (Al₂O₃) to make aqueous slurry. Then, the resulting slurry may be coated as washcoat 104 on substrate 102, dried and fired at about 550° C. for about 4 hours. The preparation of overcoat 106 may begin by making powder first. Subsequently, a sol of Y nitrate and Mn nitrate may be made. Then, incipient wetness method may be employed to add drop wise of Y—Mn solution to the doped ZrO₂ in order to have about 8% by weight of Y and about 5% by weight of Mn in powder. Then, resulting powder may be dried at about 120° C. and calcined at about 700° C. for about 5 hours. After calcination the powder may be ground and meshed, resulting in YMnO₃/ZrO₂. Obtained YMnO₃/ZrO₂ powder may be milled with water to make aqueous slurry. The resulting slurry may be coated as overcoat 106 on washcoat 104, fired at 700° C. for about 5 hours. The impregnation layer 108 may be prepared by mixing the appropriate amount of Mn nitrate solution (₂), and Cu nitrate solution with water to make solution at appropriate molar ratio for Cu₁Mn₂O₄, according to formulation CuₓMn₃₋ₓO₄, in which x may take value of 1.0, and where copper loading may be about 30 g/L and manganese loading may be about 50 g/L. Subsequently, Cu—Mn solution may be impregnated to overcoat 106, then fired (calcined) at a temperature within a range of about 550° C. to about 800° C., preferably at about 700° C. for about 5 hours.

Isothermal Oscillating TWC Test Procedure

The isothermal oscillating TWC test may be carried out employing a flow reactor at inlet temperature of about 600° C., and frequency of 1 Hz with a fuel ratio span of 0.4.

The space velocity (SV) in the isothermal oscillating test may be adjusted at about 90,000 h⁻¹. The gas feed employed for the test may be a standard TWC gas composition, which may include about 8,000 ppm of CO, about 400 ppm of C₃H₆, about 100 ppm of C₃H₈, about 1,000 ppm of NOₓ, about 2,000 ppm of H₂, about 10% of CO₂, and about 10% of H₂O. The quantity of O₂ in the gas mix may adjust about 0.7% of O₂ to have average R value of about 1.05 (stoichiometric condition).

Isothermal Steady State Sweep Test Procedure

The isothermal steady state sweep test may be carried out employing a flow reactor at inlet temperature of about 450° C., and testing a gas stream at 11-point R-values from about 2.00 (rich condition) to about 0.80 (lean condition) to measure the CO, NO, and HC conversions.

The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of Nₓ, about 2,000 ppm of H₂, about 10% of CO₂, and about 10% of H₂O. The quantity of O₂ in the gas mix may be varied to adjust Air/Fuel (A/F) ratio within the range of R-values to test the gas stream.

ZPGM Catalyst Performance Analysis

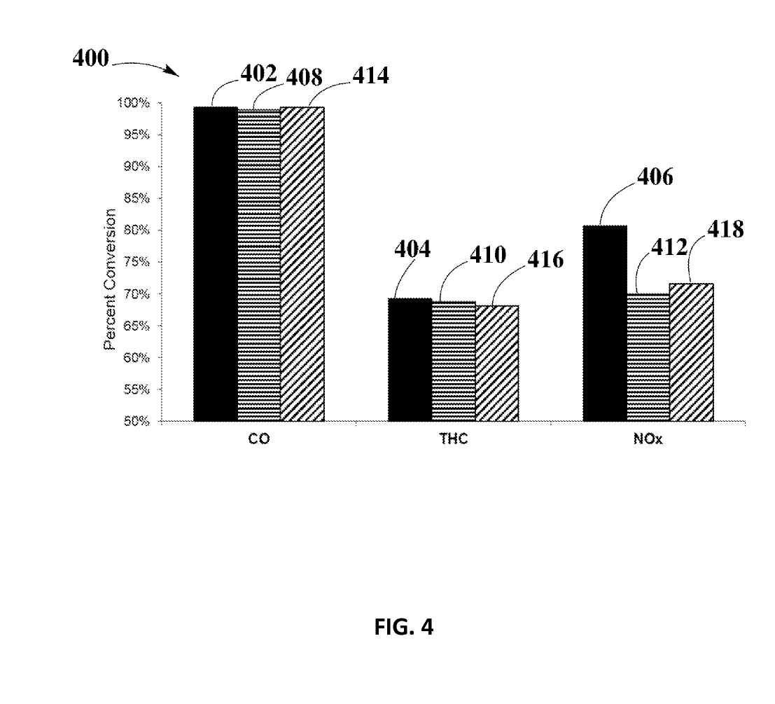

FIG. 4 depicts catalyst activity comparison 400 in NO oxidation, HC conversion, and CO conversion for samples of ZPGM catalyst system Type 1 versus samples of ZPGM catalyst system Type 2, and versus samples of ZPGM catalyst system Type 3, tested according to isothermal oscillating TWC test methodology, at temperature of about 600° C., frequency of 1 Hz, average R value of about 1.05 (stoichiometric condition), and SV of about 90,000 h⁻¹, according to an embodiment. Samples of ZPGM catalyst system Type 1, Type 2, and Type 3, were aged at 850° C. for about 20 hours, according to an embodiment.

As can be seen in FIG. 4, bar 402, bar 404, and bar 406 show levels of CO conversion, HC conversion, and NO conversion, respectively, for ZPGM catalyst system Type 1. Similarly, bar 408, bar 410, and bar 412 show levels of CO conversion, HC conversion, and NO conversion, respectively, for ZPGM catalyst system Type 2; and bar 414, bar 416, and bar 418 show levels of CO conversion, HC conversion and NO conversion, respectively for ZPGM catalyst system Type 3.

As may be seen in catalyst activity comparison 400, where disclosed ZPGM catalysts systems were aged at 850° C. for about 20 hours under fuel cut condition, bar 402 shows 99.0% CO conversion, bar 404 shows 69.0% HC conversion, and bar 406 shows 81.0% NO conversion for ZPGM catalyst system Type 1. Bar 408 depicts 99.0% CO conversion, bar 410 depicts 69.0% HC conversion, and bar 412 depicts 70.0% NO conversion for ZPGM catalyst system Type 2. Similarly, Bar 414 depicts a 99.0% CO conversion, bar 416 depicts 68.0% HC conversion, and bar 418 depicts 72.0% NO conversion for ZPGM catalyst system Type 3.

It may be observed that there is a significant improvement in NO oxidation in ZPGM catalyst system Type 1 (NO conversion of about 81%) which may be due to the presence of a Cu_{1.5}Mn_{1.5}O₄ spinel within impregnation layer 108. ZPGM catalyst system Type 2 and ZPGM catalyst system Type 3 show similar NO conversion capabilities, which are lower than ZPGM catalyst system Type 1. It may also be noticed that all disclosed aged at 850° C. ZPGM catalyst systems, being tested, exhibit similar CO and HC conversion capabilities.

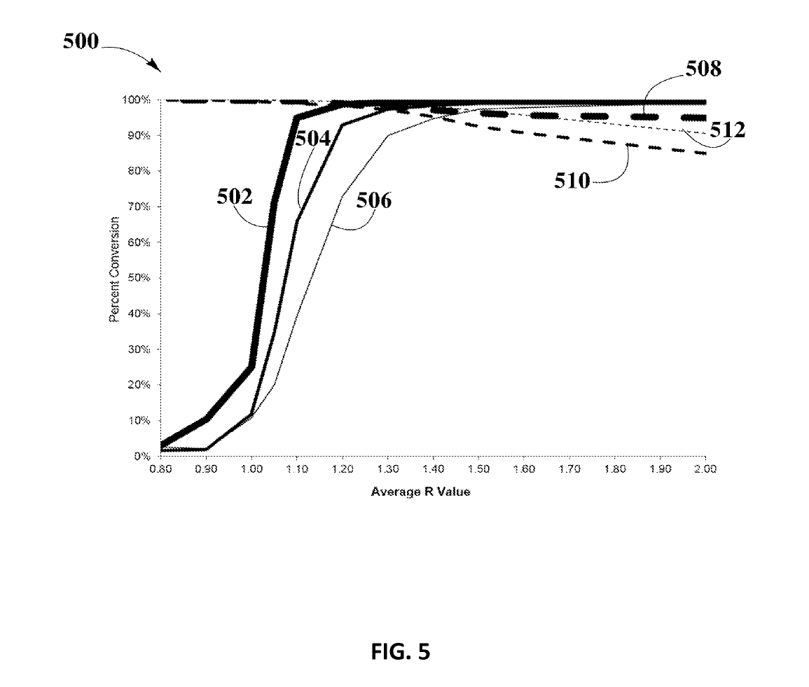

FIG. 5 shows catalyst performance comparison 500 for samples of ZPGM catalyst system Type 1, Type 2, and Type 3, under isothermal steady state sweep condition, from R-value of about 2.0 (rich condition) to about 0.80 (lean condition), at inlet temperature of about 450° C. and SV of about 40,000 h⁻¹, according to an embodiment. Samples of ZPGM catalyst system Type 1, Type 2, and Type 3, were aged at 850° C. for about 20 hours.

In FIG. 5, NO conversion curve 502, NO conversion curve 504, and NO conversion curve 506 show NO conversion results for ZPGM catalyst system Type 1, ZPGM catalyst system Type 2, and ZPGM catalyst system Type 3, respectively. CO conversion curve 508, CO conversion curve 510, and CO conversion curve 512 show CO conversion results for ZPGM catalyst system Type 1, ZPGM catalyst system Type 2, and ZPGM catalyst system Type 3, respectively.

As may be observed in FIG. 5, results from isothermal steady state sweep test reveal significant high aged activity for all ZPGM catalyst systems. As may be observed in NO conversion curve 502 for ZPGM catalyst system Type 1. ZPGM catalyst system Type 1 exhibit higher level of NOx conversion compared to ZPGM catalyst system Type 2 (NO conversion curve 504), and also compared to ZPGM catalyst system Type 3 (NO conversion curve 506). For example, at an R-value of 1.1 (rich condition, close to stoichiometric condition) tested samples of ZPGM catalyst system Type 1 exhibit NOx conversion of about 94.9%, while ZPGM catalyst system Type 2, and ZPGM catalyst system Type 3 exhibit NOx conversion of about 65.9%, and 39.4%, respectively.

By considering CO conversion curves (CO conversion curve 508,510, and 512), the NO/CO cross over R-value, where NO and CO conversions are equal, for ZPGM catalyst system Type 1, the NO/CO cross over R-value takes place at the specific R-value of 1.22. Moreover, for ZPGM catalyst system Type 2, NO/CO cross over R-value takes place at the specific R-value of 1.30, and for ZPGM catalyst system Type 3, NO/CO cross over R-value takes place at the specific R-value of 1.49.

As may be seen in FIG. 5, at NO/CO cross over R-value of 1.22 for ZPGM catalyst system Type 1, NO and CO conversion is about 99% of, while HC conversion is of about 56%. At NO/CO cross over R-value of 1.30 for ZPGM catalyst system Type 2, NO and CO conversion is about 97%, while HC conversion is of about 47%. Moreover, NO/CO cross over R-value of 1.49 for ZPGM catalyst system Type 3, NO and CO conversion is about 97%, while HC conversion is of about 25%.

These results show that ZPGM catalyst system Type 1 with Cu_{1.5}Mn_{1.5}O₄ spinel composition in impregnation layer 108 and overcoat 106 of ZrO₂, exhibit higher TWC performance under either oscillating or steady state condition after fuel cut aging at 850° C., for about 20 hours while compared to Cu₁Mn₂O₄ spinel in combination with another ZPGM component, such as YMnO₃ with perovskite structure, or a Cu₁Co₁Mn₁O₄ spinel composition with high quantities of OSM. In fact, for aging condition suitable for under floor position for TWC application, Cu_{1.5}Mn_{1.5}O₄ spinel shows high performance, showing that there is no advantage in doping Cu—Mn spinel with cobalt, or using oxygen storage materials. In addition, there is no advantage in using combination of Cu—Mn spinel with Y—Mn perovskite.

In order to check thermal stability, disclosed ZPGM catalyst systems were also tested after aging at about 900° C., for about 20 hours under fuel cut condition.

ZPGM Catalyst Stability Analysis

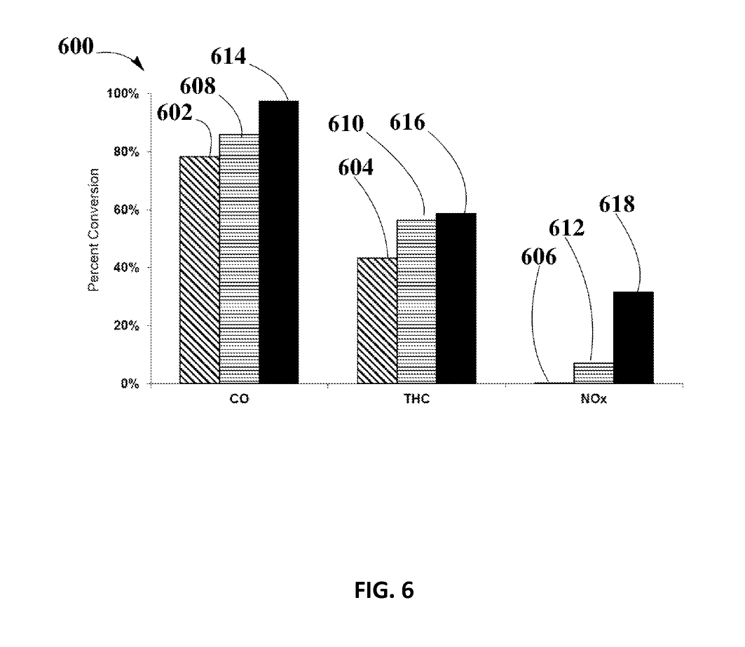

FIG. 6 depicts catalyst activity comparison 600 in NO oxidation, HC conversion, and CO comparison for samples of ZPGM catalyst system Type 1 versus samples of ZPGM catalyst system Type 2, and versus samples of ZPGM catalyst system Type 3, tested according to isothermal oscillating TWC test methodology, at temperature of about 600° C., frequency of 1 Hz, average R value of about 1.05 (stoichiometric condition), and SV of about 90,000 h⁻¹, according to an embodiment. Samples of ZPGM catalyst system Type 1, Type 2, and Type 3, were aged at 900° C. for about 20 hours, according to an embodiment.

As can be seen in FIG. 6, bar 602, bar 604, and bar 606 show levels of CO conversion, HC conversion, and NO conversion, respectively, for ZPGM catalyst system Type 1. Similarly, bar 608, bar 610, and bar 612 show levels of CO conversion, HC conversion, and NO conversion, respectively, for ZPGM catalyst system Type 2; and bar 614, bar 616, and bar 618 show levels of CO conversion, HC conversion, and NO conversion, respectively for ZPGM catalyst system Type 3.

As may be seen in catalyst activity comparison 600, where disclosed ZPGM catalysts systems were aged at 900° C. for about 20 hours under fuel cut condition, bar 602 shows 78.0% CO conversion, bar 604 shows 43.0% HC conversion, and bar 606 shows no NO conversion for ZPGM catalyst system Type 1. Bar 608 depicts 86.0% CO conversion, bar 610 depicts 56.0% HC conversion, and bar 612 depicts 7.0% NO conversion for ZPGM catalyst system Type 2. Similarly, Bar 614 depicts a 97.0% CO conversion, bar 616 depicts 59.0% HC conversion, and bar 618 depicts 32.0% NO conversion for ZPGM catalyst system Type 3.

It may be observed that there is a significant improvement in CO, HC, and NO conversions, for ZPGM catalyst system Type 3 after fuel cut aging at 900° C. Samples aged at 900° C. of ZPGM catalyst system Type 1, and ZPGM catalyst system Type 2 show very low activity, showing ZPGM catalyst system type 3 including combination of Cu—Mn spinel and Y—Mn perovskite has higher thermal stability, which may be because of the synergistic effect between perovskite in overcoat 106 and spinel in impregnation layer 108.

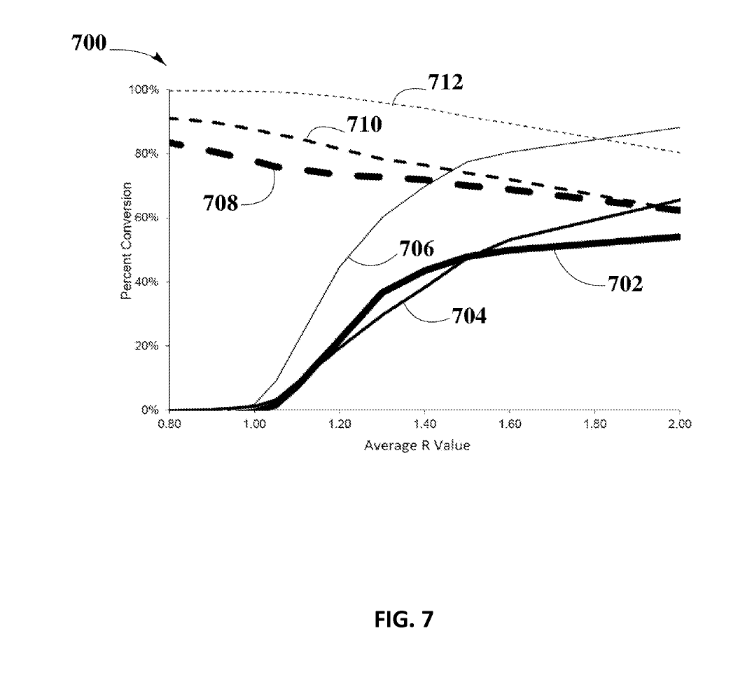

FIG. 7 shows catalyst performance comparison 700 for samples of ZPGM catalyst system Type 1, Type 2, and Type 3, under isothermal steady state sweep condition, from R-value of about 2.0 (rich condition) to about 0.80 (lean condition), at inlet temperature of about 450° C. and SV of about 40,000 h⁻¹, according to an embodiment. Samples of ZPGM catalyst system Type 1, Type 2, and Type 3, were aged at 900° C. for about 20 hours.

In FIG. 7, NO conversion curve 702, NO conversion curve 704, and NO conversion curve 706 show NO conversion results for ZPGM catalyst system Type 1, ZPGM catalyst system Type 2, and ZPGM catalyst system Type 3, respectively. CO conversion curve 708, CO conversion curve 710, and CO conversion curve 712 show CO conversion results for ZPGM catalyst system Type 1, ZPGM catalyst system Type 2, and ZPGM catalyst system Type 3, respectively.

As may be observed in FIG. 7, results from isothermal steady state sweep test reveal significant improved NO and CO conversion for ZPGM catalyst system Type 3. As may be observed in NO conversion curve 702 for ZPGM catalyst system Type 1 and ZPGM catalyst system Type 2 (NO conversion curve 704), exhibit similar level of NOx conversion. For example, after fuel cut aging at 900° C., at an R-value of about 1.3 (rich condition), samples of ZPGM catalyst system Type 1 exhibit NOx conversion of about 36.6%, while ZPGM catalyst system Type 2 exhibit NOx conversion of about 29.7%, and ZPGM catalyst system Type 3 exhibit NOx conversion of about 60.2%.

By considering CO conversion curves (CO conversion curve 708, 710, and 712), the NO/CO cross over R-value, where NO and CO conversions are equal, for ZPGM catalyst system Type 1, which takes place at the specific R-value above 2.0 (rich condition). Moreover, for ZPGM catalyst system Type 2, NO/CO cross over R-value takes place at the specific R-value of 1.94 (rich condition), and for ZPGM catalyst system Type 3 NO/CO cross over R-value takes place at the specific R-value of 1.81 (rich condition). These results show that ZPGM catalyst system Type 3 may exhibit better NO/CO conversion.

As may be seen in FIG. 7, there is no NO/CO cross over R-value tested for ZPGM catalyst system Type 1, however extrapolation of NO and CO conversion curves 708 shows the NO/CO cross over may take place at R value above 2.0 (rich condition), in which NO and CO conversion is around 50%. At NO/CO cross over R-value of 1.94 (rich condition) for ZPGM catalyst system Type 2, NO and CO conversion is about 64%, while HC conversion is about 19%. Moreover, at NO/CO cross over R-value of 1.81 (rich condition) for ZPGM catalyst system Type 3, NO and CO conversion of about 85%, while HC conversion is of about 13%.

These results shows higher activity of ZPGM catalyst system Type 3 after fuel cut aging at 900° C. in comparison with ZPGM catalyst system Type 1 and ZPGM catalyst system Type 2. The improved activity of ZPGM catalyst system of Type 3 may be due to the synergistic effect between Cu—Mn spinel and Y—Mn perovskite which helps to improve thermal stability of Cu—Mn spinel. Moreover, addition of cobalt to Cu—Mn spinel structure in presence of OSM helps the thermal stability of Cu—Mn catalysts composition. The thermal stability may be significantly enhanced by the synergistic effect between Cu₁Mn₂O₄ spinel and perovskite YMnO₃within configuration of ZPGM catalyst system Type 3.

Results from isothermal steady state sweep test and isothermal oscillating TWC test for fuel cut aging at 850° C. and 900° C. show that Cu_{1.5}Mn_{1.5}O₄ spinel composition in impregnation layer exhibits higher TWC performance after fuel cut aging at 850° C., for about 20 hours which is suitable for under floor position aging. However, by increasing the temperature of aging to 900° C., it is notable that Cu_{1.5}Mn_{1.5}O₄ spinel does not show thermal stability and combination of Cu—Mn spinel with another ZPGM component, such as YMnO₃ with perovskite structure improved significantly the thermal stability of Cu—Mn spinel system. In addition, the thermal stability of Cu—Mn spinel increased by Co doping to form Cu—Co—Mn spinel composition, however the advantages obtained by synergistic effect of Cu—Mn spinel with Y—Mn perovskite is more significant.

-The present disclosure may provide ZPGM catalyst systems with different material compositions including CuₓMn₃₋ₓO₄ spinel (where x=0.5-1.5), and CuₓCo_{y}Mn_{3-x-y}O₄ (x,y=0.02 to 1) spinel within impregnation layers in presence of OSM or new ZPGM catalyst structure such as perovskite in order to develop suitable catalytic layers capable of providing high reactivity and thermal stability for ZPGM catalysts.

-In one embodiment, a ZPGM may include an alumina-based washcoat layer coated on a ceramic substrate, an overcoat layer of doped ZrO₂, and an impregnation layer with CuₓMn₃₋ₓO₄ spinel, where x=1.5.

-In another embodiment, a ZPGM may include an alumina-based washcoat layer coated on a ceramic substrate, an overcoat layer with a suitable OSM, and an impregnation layer with CuₓCo_{y}Mn_{3-x-y}O₄ spinel, where x=y=1.0.

-In a further embodiment, a ZPGM may include an alumina-based washcoat layer coated on a ceramic substrate, an overcoat layer with a combination of a ZPGM with zirconia type support oxide, such as YMnO₃/doped ZrO₂, and an impregnation layer with CuₓMn₃₋ₓO₄ spinel, where x=1.0.

-the activity results for aging temp of 850° C. (under floor aging temp range) show that ZPGM catalyst system Type 1 with Cu_{1.5}Mn_{1.5}O₄ spinel composition in impregnation layer and overcoat layer of ZrO₂, exhibits higher TWC performance under either oscillating or steady state condition after fuel cut aging at 850° C., for about 20 hours while compare to Cu₁Mn₂O₄ spinel in present of another ZPGM composition such as YMnO₃ with perovskite structure, or a Cu₁Co₁Mn₁O₄ spinel composition in present of lots of OSM. In fact, for aging condition appropriate for under floor position for TWC application, Cu_{1.5}Mn_{1.5}O₄ spinel composition shows optimum performance and there is no advantage in doping Cu—Mn spinel with Cobalt, or using oxygen storage material. In addition, there is no advantage in using synergistic effect of Cu—Mn spinel with Y—Mn perovskite.

-the activity results for aging temp of 900° C. (higher rang of temp for under floor position) show higher activity of ZPGM catalyst system Type 3 in comparison to ZPGM catalyst system Type 1 and ZPGM catalyst system Type 2. The higher performance of ZPGM catalyst system Type 3 may be explained by synergistic effect between Cu—Mn spienl and Y—Mn perovskite which helps to improve thermal stability of Cu—Mn spinel. In addition, addition of cobalt to Cu—Mn spinel structure in presence of OSM helps the thermal stability of Cu—Mn catalysts composition. The thermal stability may be significantly enhanced by the synergistic effect between Cu₁Mn₂O₄ spinel and perovskite YMnO₃ within configuration of ZPGM catalyst system Type 3.

-Results from isothermal steady state sweep test and isothermal oscillating TWC test for fuel cut aging at 850° C. and 900° C. show that Cu_{1.5}Mn_{1.5}O₄spinel composition in impregnation layer, exhibits higher TWC performance after fuel cut aging at 850° C., for about 20 hours which is suitable for under floor position aging. However, by increasing the temperature of aging to 900° C., it is notable that Cu_{1.5}Mn_{1.5}O₄ spinel does not show thermal stability and combination of Cu—Mn spinel with another ZPGM composition such as YMnO3 with perovskite structure improved significantly the thermal stability of Cu—Mn spinel system. In addition, the thermal stability of Cu—Mn spinel increased by Co doping to form Cu—Co—Mn spinel composition, however the advantages obtained by synergistic effect of Cu—Mn spinel with Y—Mn perovskite is more significant.

1. A zero platinum group metal (ZPGM) catalyst system comprising
a) an overcoat layer comprising a combination of a ZPGM with a doped zirconia, and
b) an impregnation layer comprising Cu—Mn spinel.

2. The ZPGM catalyst system of claim 1, wherein the zirconia type support oxide is YMnO₃/doped ZrO₂.

3. The ZPGM catalyst system of claim 1, wherein Cu—Mn spinel is according to the formula CuₓMn₃₋ₓO₄.

4. The ZPGM catalyst system of claim 3, wherein X is 1.

5. The ZPGM catalyst system of claim 3, wherein X is 1.5.

6. The ZPGM catalyst system of claim 1, wherein the Cu—Mn spinel is CuCoMnO₄ spinel.

7. The ZPGM catalyst system of claim 1 further comprising an alumina-based washcoat layer coated on a ceramic substrate.

8. A zero platinum group metal (ZPGM) catalyst system comprising
a) an overcoat layer comprising Y—Mn perovskite, and
b) an impregnation layer comprises Cu—Mn spinel.

9. The ZPGM catalyst system of claim 8, wherein the Y—Mn perovskite is perovskite YMnO₃.

10. The ZPGM catalyst system of claim 8, wherein Cu—Mn spinel is according to the formula CuₓMn₃₋ₓO₄.

11. The ZPGM catalyst system of claim 10, wherein X is 1.

12. The ZPGM catalyst system of claim 10, wherein X is 1.5.

13. The ZPGM catalyst system of claim 8, wherein the Cu—Mn spinel is CuCoMnO₄ spinel.

14. The ZPGM catalyst system of claim 8 further comprising an alumina-based washcoat layer coated on a ceramic substrate.

15. A method of producing an aged zero platinum group metal (ZPGM) catalyst system comprising aging the ZPGM catalyst system at a temperature of about 850° C. to about 900° C. for about 20 hours, wherein the ZPGM catalyst system comprises a) an overcoat layer comprising a combination of a ZPGM with a doped zirconia, and b) an impregnation layer comprising Cu—Mn spinel.

16. The method of claim 15, wherein the zirconia type support oxide is YMnO₃/doped ZrO₂.

17. The method of claim 16, wherein the Cu—Mn spinel is CuMn₂O₄ spinel.

18. A method of producing an aged zero platinum group metal (ZPGM) catalyst system comprising aging the ZPGM catalyst system at a temperature of about 850° C. to about 900° C. for about 20 hours, wherein the ZPGM catalyst system comprises a) the overcoat layer comprises Y—Mn perovskite, and b) the impregnation layer comprises Cu—Mn spinel.

19. The method of claim 18, wherein the Y—Mn perovskite is perovskite YMnO₃.

20. The method of claim 18, wherein the Cu—Mn spinel is CuMn₂O₄ spinel.
